(19) United States
(12) Patent Application Publication
(10) Pub. No.: US 2017/0332094 A1
(43) Pub. Date: Nov. 16, 2017

(54) SUPER-WIDE AREA MOTION ESTIMATION FOR VIDEO CODING

(71) Applicant: GOOGLE INC., Mountain View, CA (US)

(72) Inventor: Juha Pekka Maaninen, Oulu (FI)

(21) Appl. No.: 15/380,192

(22) Filed: Dec. 15, 2016

Related U.S. Application Data
(60) Provisional application No. 62/336,935, filed on May 16, 2016.

(51) Int. Cl. H04N 19/513; H04N 19/105; H04N 19/176; H04N 19/172; H04N 19/184; H04N 19/182

(52) U.S. Cl. CPC H04N 19/513; H04N 19/105; H04N 19/182; H04N 19/172; H04N 19/184; H04N 19/176

(57) ABSTRACT

Super-wide area motion estimation can include multiple stages of motion search as part of a process for encoding or decoding frames of a video sequence. A first stage motion search includes using a first motion search window centered at a position corresponding to a position of a super index element, which can indicate an area of a frame having motion. An area of possible motion can be determined in response to the first stage motion search to indicate a list of superblocks that are likely to include motion within the frame. A second stage motion search is then performed on superblocks of the list using another motion search window centered at a position corresponding to the area of possible motion. The list of superblocks to be searched in the second stage can be maintained in a cache to reduce memory requirements.

### CROSS-REFERENCE TO RELATED APPLICATION(S)

This disclosure claims priority to U.S. Provisional Application No. 62/336,935, filed May 16, 2016, which is incorporated herein in its entirety by reference.

### BACKGROUND

Digital video streams typically represent video using a sequence of frames or still images. Each frame can include a number of blocks, which in turn may contain information describing the value of color, brightness or other attributes for pixels. The amount of data in a typical video stream is large, and transmission and storage of video can use significant computing or communications resources. Due to the large amount of data involved in video data, high performance compression and decompression is needed for transmission and storage.

### SUMMARY

This disclosure relates generally to encoding and decoding video data and more particularly relates to using super-wide area motion estimation for video coding.

An apparatus according to one implementation of the disclosure is provided for encoding a block of a current frame of a video sequence. The apparatus comprises a processor. The processor is configured to execute instructions stored in a non-transitory storage medium to perform a first motion search on the current frame to determine an area of possible motion. The processor is further configured to execute instructions stored in a non-transitory storage medium to identify a list of superblocks likely to include motion within the current frame based on the area of possible motion. The processor is further configured to execute instructions stored in a non-transitory storage medium to perform a second motion search on one or more superblocks of the list of superblocks. The processor is further configured to execute instructions stored in a non-transitory storage medium to generate a prediction block based on results of the second motion search, wherein the block of the current frame is encodable using the prediction block.

An apparatus according to another implementation of the disclosure is provided for decoding a block of an encoded frame included in an encoded bitstream. The apparatus comprises a processor. The processor is configured to execute instructions stored in a non-transitory storage medium to perform a first motion search on the encoded frame to determine an area of possible motion. The processor is further configured to execute instructions stored in a non-transitory storage medium to identify a list of superblocks likely to include motion within the encoded frame based on the area of possible motion. The processor is further configured to execute instructions stored in a non-transitory storage medium to perform a second motion search on one or more superblocks of the list of superblocks. The processor is further configured to execute instructions stored in a non-transitory storage medium to generate a prediction block based on results of the second motion search, wherein the block of the encoded frame is decodable using the prediction block.

A method according to one implementation of this disclosure is provided for decoding an encoded video signal using a computing device, the encoded video signal including an encoded frame. The method comprises performing a first motion search on the encoded frame to determine an area of possible motion. The method further comprises identifying a list of superblocks likely to include motion within the encoded frame based on the area of possible motion. The method further comprises performing a second motion search on one or more superblocks of the list of superblocks. The method further comprises generating a prediction block based on results of the second motion search, wherein a block of the encoded frame is decodable using the prediction block.

These and other aspects of the present disclosure are disclosed in the following detailed description of the embodiments, the appended claims and the accompanying figures.

### BRIEF DESCRIPTION OF THE DRAWINGS

The description herein makes reference to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a video stream to be encoded and subsequently decoded.

FIG. 4 is a block diagram of an encoder according to implementations of this disclosure.

FIG. 5 is a block diagram of a decoder according to implementations of this disclosure.

FIG. 6 is a block diagram showing an example of using super-wide area motion estimation for encoding or decoding frames of a video sequence.

FIG. 7 is a flowchart diagram of a process for super-wide area motion estimation for encoding or decoding frames of a video sequence.

### DETAILED DESCRIPTION

Video compression schemes may include breaking respective images, or frames, into smaller portions, such as blocks, and generating an output bitstream using techniques to limit the information included for respective blocks in the output. An encoded bitstream can be decoded to re-create the source images from the limited information. Typical video compression and decompression schemes use a motion search window to detect motion within a reference frame that may be located before or after a current frame in a display order of the video sequence, but is located before the current frame in an encoding or decoding order. If motion is detected within a portion of the reference frame, that portion of the reference frame is compared to a corresponding portion of the current frame. If the results of the comparison indicate that the corresponding portions of the reference frame and current frame are similar, the reference frame can be used to predict the motion of the current frame during an encoding or decoding process.

The motion search window typically has limited dimensions such that it cannot detect motion in an entire frame. Further, in some cases, such as in the context of a hardware encoder or decoder, the motion search window is fixed about a particular pixel position within the frame. However, as video technology improves and resolutions increase, a fixed motion search window may only able to detect motion within a relatively small portion of the frame. For example, it can be difficult for a fixed motion search window to track motion within a frame of a 4K video sequence. A restricted motion search can result in poor compression efficiency and poor visual quality for the compressed video sequence.

At least a portion of the reference frame must be stored within hardware memory, such as an external dynamic random access memory (DRAM), for motion estimation to be performed. As a threshold step to motion estimation, a reference frame storage can pre-fetch reference frame data from hardware memory that stores an entire reference frame. The pre-fetching is performed to verify that all of the data to be used for the motion estimation can be accessed at the time the motion estimation is performed. However, this places limitations on the motion estimation. For example, the motion search window remains fixed around a given pixel position since the reference frame storage pre-fetches the reference frame data from hardware memory. In the event that portions of the frame are moving in a first direct and other portions are moving in a second direction, there may be no way to adjust the location of the motion search window during a motion estimation operation without incurring substantial onboard storage issues.

One solution may be to include a fixed shift to the motion search window. With a fixed shift, if a previous frame was determined to include motion mostly towards a single portion of the frame, the motion search window can be adjusted such that it can be centered at or near the single portion within the next frame. However, this solution can be unreliable in that any adjustment has a one frame lag. Further, it does not improve motion estimation where portions of the frame are moving in opposite directions. Another solution may include using tile coding to reduce onboard memory (e.g., static random access memory (SRAM)) requirements. In tile coding, a frame can be divided into multiple vertical chunks, or tiles, wherein each tile can be separately encoded. However, because the motion search window can overlap tiles, tile coding adds additional bandwidth to the encoder. For example, given a window of +/−128 pixels horizontally and a tile width of 512 pixels, the total bandwidth for encoding the frame is actually 1.5 times the frame size.

Implementations of the present disclosure include systems and methods for super-wide area motion estimation for video coding using a non-fixed motion search window. The motion estimation is performed in multiple stages that include processing data with respect to one or more superblocks of a current frame. At a first stage, a first motion search window searches for motion within a heavily indexed portion of a current superblock of the current frame. An assumption area of where the motion for the superblock resides is determined at the first stage. The assumption area indicates the superblocks of the current frame that include motion. At a second stage, a second motion search window is centered around the assumption area within the current frame. The second motion search window can be smaller in size than the first motion search window so as to provide a more focused search area. Motion data resulting from the second stage is usable to predict motion within the current frame.

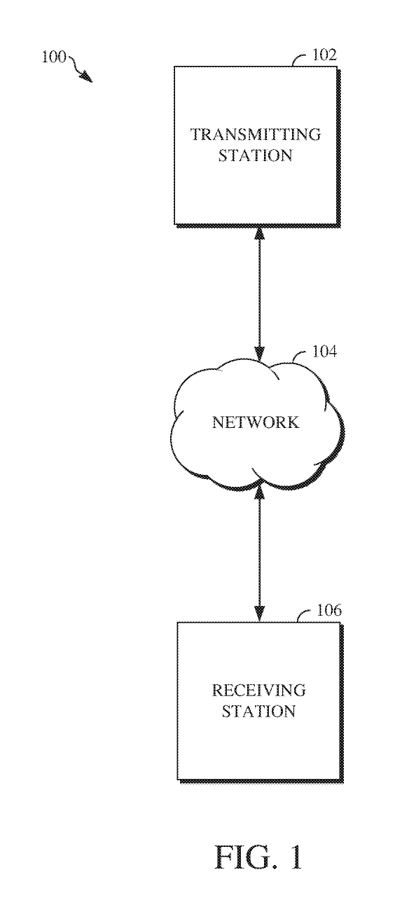

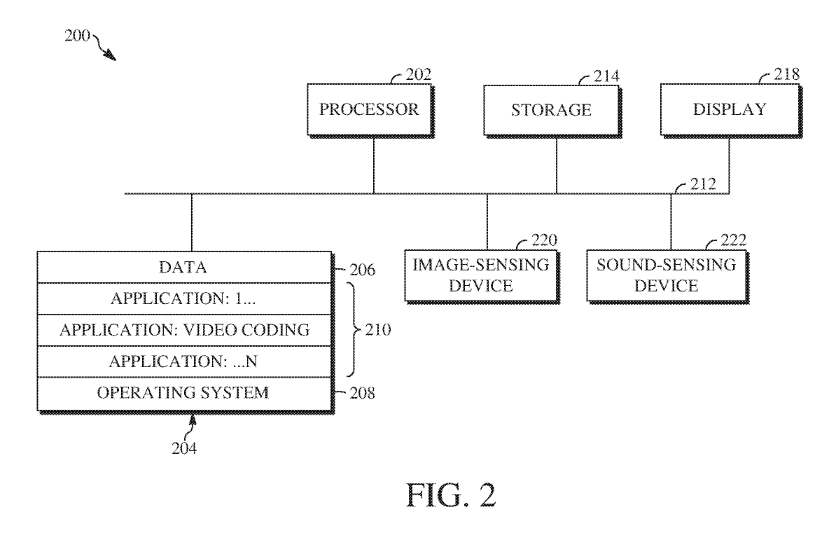

Further details of using super-wide area motion estimation for video coding are described herein with initial reference to a system in which it can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP)-based video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a central processing unit (CPU). Alternatively, the processor 202 can be any other type of device, or multiple devices, capable of manipulating or processing information now-existing or hereafter developed. Although the disclosed implementations can be practiced with one processor as shown (e.g., the processor 202), advantages in speed and efficiency can be achieved using more than one processor.

A memory 204 in computing device 200 can be a read only memory (ROM) device or a random access memory (RAM) device in an implementation. Any other suitable type of storage device can be used as the memory 204. The memory 204 can include data 206 that is accessed by the processor 202 using a bus 212. The memory 204 can further include an operating system 208 and application programs 210. The application programs 210 include at least one program (e.g., the applications 1 through N) that permits the processor 202 to perform the methods described herein, such as to perform super-wide area motion estimation. The computing device 200 can also include a storage 214, which can, for example, be a memory card used with a mobile computing device. Because the video communication sessions may contain a significant amount of information, they can be stored in whole or in part in the storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (each machine having one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

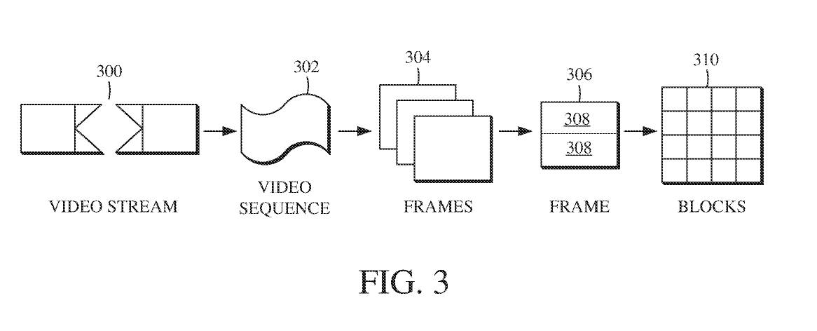

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, such as a frame 306. At the next level, the frame 306 can be divided into a series of segments 308. The segments 308 can be subsets of frames that permit parallel processing, for example. The segments 308 can also be subsets of frames that can separate the video data into separate colors. For example, the frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels or larger. Unless otherwise noted, the terms block and macroblock are used interchangeably herein.

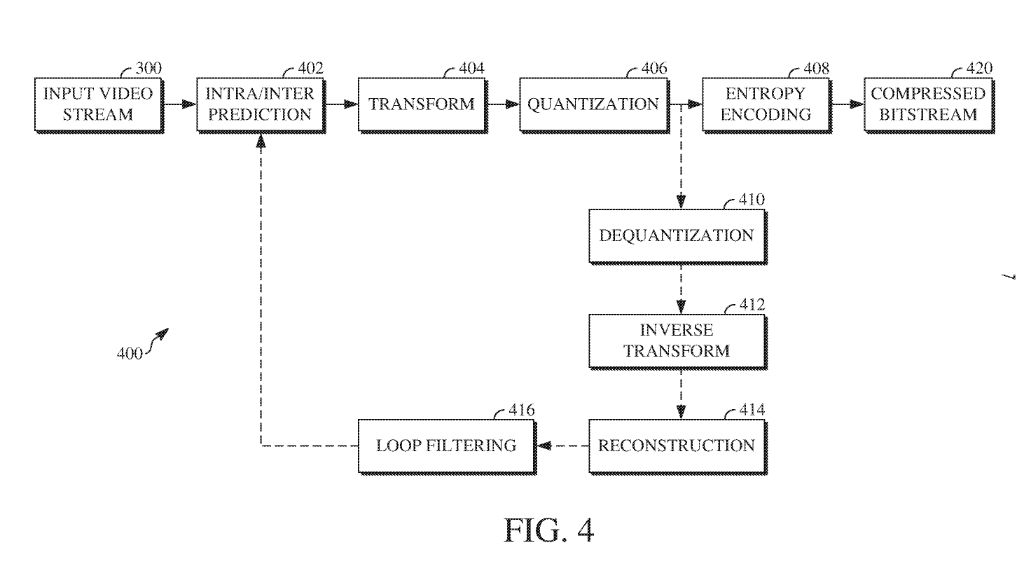

FIG. 4 is a block diagram of an encoder 400 according to implementations of this disclosure. The encoder 400 can be implemented, as described above, in the transmitting station 102 such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

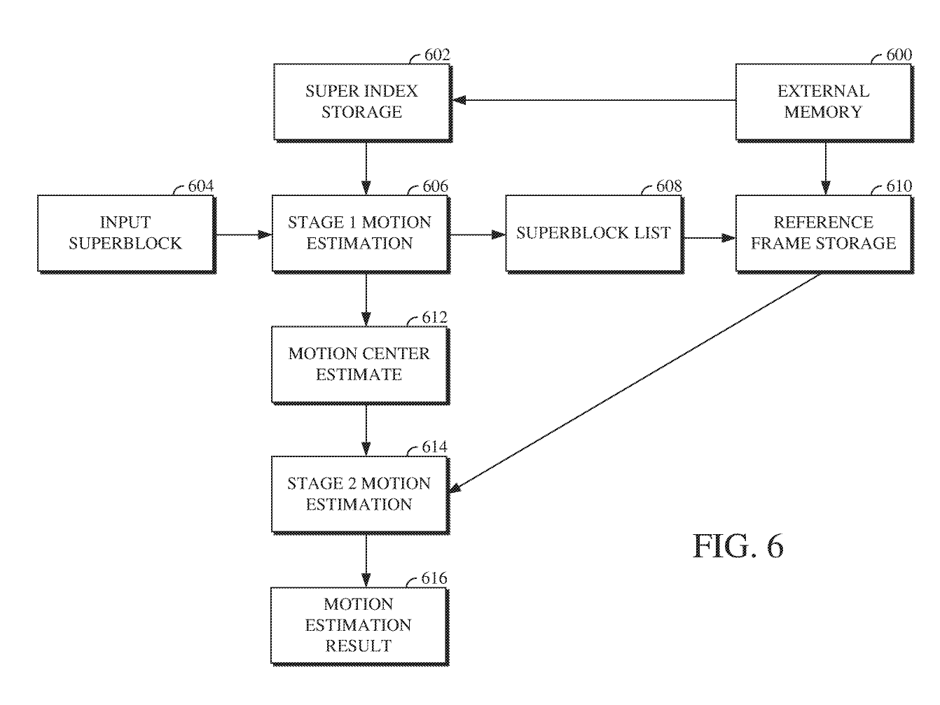

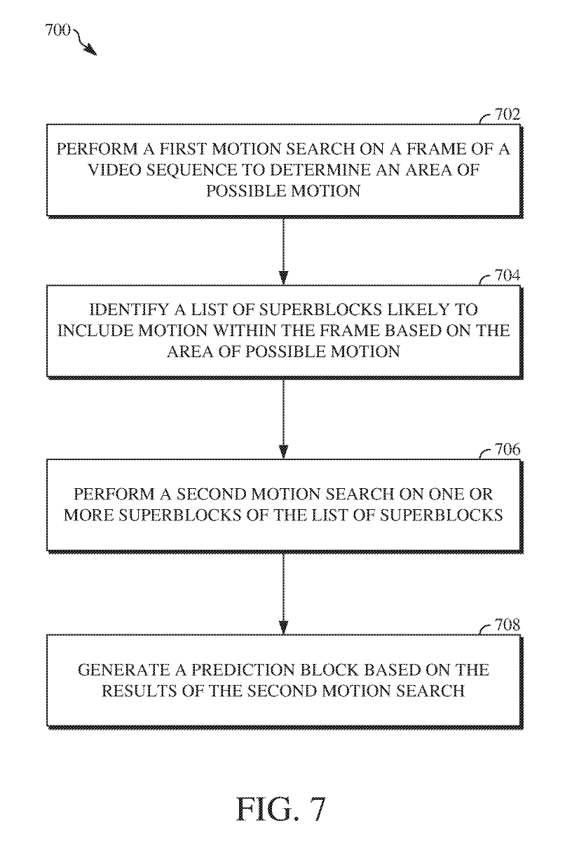

When the video stream 300 is presented for encoding, respective ones of the adjacent frames 304, such as the frame 306, can be processed in units of blocks. At the intra/inter prediction stage 402, each block can be encoded using intra-frame prediction (also called intra prediction) or inter-frame prediction (also called inter prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames. Implementations for performing super-wide motion estimation as part of the intra/inter prediction stage 402 of the encoder 400 are discussed below with respect to FIGS. 6 and 7, for example, using motion search windows of the intra/inter prediction stage 402.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform based encoder can quantize the residual signal directly without the transform stage 404 for certain blocks or frames. In another implementation, an encoder can have the quantization stage 406 and the dequantization stage 410 combined in a common stage.

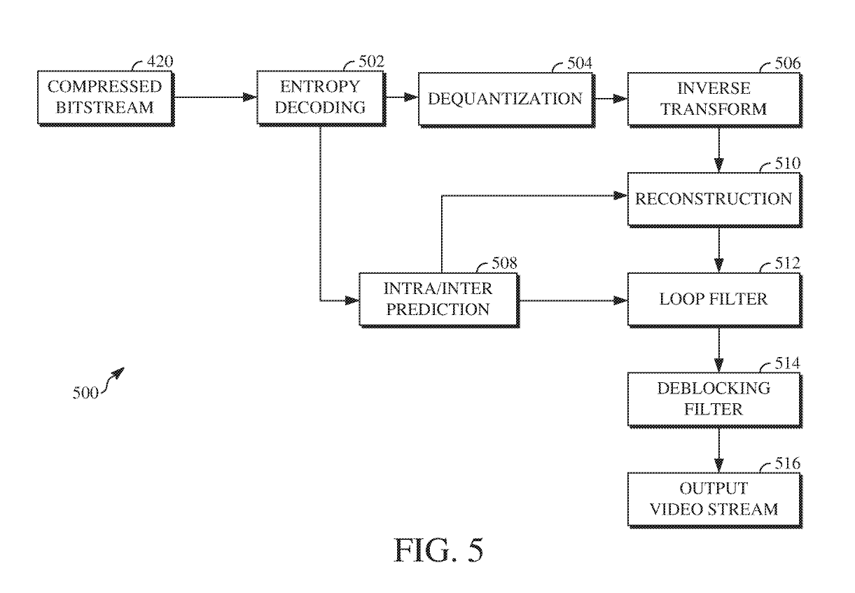

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. Implementations for performing super-wide motion estimation as part of the intra/inter prediction stage 508 of the decoder 500 are discussed below with respect to FIGS. 6 and 7, for example, using motion search windows of the intra/inter prediction stage 508.

At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the deblocking filtering stage 514.

FIG. 6 is a block diagram showing an example of using super-wide area motion estimation for encoding or decoding frames of a video sequence. Super-wide area motion estimation can be implemented by encoder or decoder, for example, as part of a process for predicting motion within a frame of a video sequence to be encoded or decoded. Super-wide area motion estimation can be implemented in hardware included in, for example, the transmitting station 102 or the receiving station 106.

Super-wide area motion estimation is performed using an external memory 600, a super index storage 602, an input superblock 604, a superblock list 608, a reference frame storage 610, and a motion center estimate 612. The stages of super-wide area motion estimation include a stage 1 motion estimation 606 and a stage 2 motion estimation 614. A motion estimation result 616 is generated, determined, or otherwise identified responsive to the stage 2 motion estimation 614. Other variations of super-wide area motion estimation can be used to predict the motion with a current frame of a video sequence to be encoded or decoded.

The external memory 600 is a hardware memory that stores data associated with a video sequence to be encoded or decoded. In particular, the external memory 600 stores reference frames to be pre-fetched by the reference frame storage 610. The external memory 600 also stores data indicative of super indexes to be pre-fetched by the super index storage 602. The external memory 600 can be DRAM. Alternatively, the external memory can be another type of memory described above with respect to the memory 204 shown in FIG. 2.

As used herein, a super index refers to an M×N (e.g., 8×16, 16×16, etc.) area of pixels within a frame to be encoded or decoded. A super index may correspond to a region of a reference frame most likely to include motion. As such, a super index pre-fetched by the super index storage 602 corresponds with a reference frame pre-fetched by reference frame storage 610. An element of a super index, interchangeably referred to herein as a super index element, can refer to a pixel of a reference frame to be used during motion estimation. A super index element may, for example, be identified as a two-dimensional coordinate value, which refers to a pixel value located at a corresponding row and column position of the reference frame. A super index element may be used as the center of a motion search window used to perform motion estimation on the reference frame. The following formula can be used to determine a super index element:

$$I ( i , j ) = {\sum }_{r = 0}^{N} {\sum }_{s = 0}^{N} P ( 16 i + r , 16 j + s )$$

where I(i, j) represents a super index element at the i^{th} row and j^{th} column of a superblock of the reference frame and P(i, j) represents the pixel value at the i^{th} row and j^{th} column of the reference frame.

Memory can be saved by using a super index element to guide the location for performing motion estimation. For example, the super index size for a 2,160P frame would be (3,840/16)×(2,160/16)=32,400 elements. The valid value range for a super index element can be 0 to 65,280 (16×16×255). As such, a super index element may be stored using 16 bits of onboard memory. Storing the luminance data for an entire 2,160P frame in super-indexed format may therefore use 64,800 bits of onboard memory per reference frame. This is substantially less than the 8,294,400 bytes required to store the raw pixel data.

An input superblock 604 can be used along with data stored in the super index storage 602 to perform the stage 1 motion estimation 606. The stage 1 motion estimation 606 includes performing a first motion search against the input superblock 604 using a first motion search window. The first motion search window is centered at a pixel position corresponding to a super index element pre-fetched by the super index storage 602. As such, the input superblock 604 is selected by identifying a superblock of the reference frame corresponding to a super index element pre-fetched by the super index storage 602.

The first motion search window searches for motion at an area of the input superblock 604 corresponding to an area of the reference frame (e.g., which reference frame corresponds to the super index element pre-fetched by the super index storage 602). The motion center estimate is determined in response to the stage 1 motion estimation 606. The motion center estimate 612 indicates an area of possible motion within the frame to be encoded or decoded. That is, the area of possible motion is based on an assumption made via the stage 1 motion estimation 606, which assumption regards the actual location of motion within the frame to be encoded or decoded. The area of possible motion can refer to a single pixel, a group of pixels, or any other portion of the frame to be encoded or decoded.

The superblock list 608 is also identified in response to the stage 1 motion estimation 606. The superblock list 608 comprises superblocks of the frame that are likely to include motion, as determined based on the area of possible motion. For example, the superblock list 608 can include the superblock within which the area of possible motion is located (e.g., a superblock in which the area of possible motion is at least partially located) and/or one or more superblocks adjacent to that superblock. In another example, the superblock list 608 can include four to nine superblocks, including one superblock within which the area of possible motion is located and the three to eight superblocks immediately adjacent to it. In another example, the superblock list 608 can include superblocks farther from the superblock within which the area of possible motion is located. In yet another example, the superblock list 608 can include superblocks located on one, two, or three sides (as applicable) of the superblock within which the area of possible motion is located.

The reference frame storage 610 receives data indicative of reference frames usable for performing motion estimation from the external memory 600. The pre-fetching can include retrieving or otherwise receiving a reference frame to use for the motion estimation. As described above, reference frames can be located before or after the frame to be encoded or decoded in a display order of the video sequence. For example, one reference frame for encoding a current frame is the LAST_FRAME, which is the frame immediately before the current frame in the display order of the video sequence; however, other frames can be used as the reference frame.

The superblock list 608 is communicated to the reference frame storage 610. The reference frame storage 610 uses the superblock list 608 to pre-fetch and storing in a cache all superblocks of the list that are not then-currently cached. Caching a superblock can include recording a timestamp at which the superblock is stored in the cache. In the event the cache is full when the superblock list 608 is communicated to the reference frame storage 610, those newly pre-fetched superblocks (e.g., those not then-currently cached) can overwrite those pre-fetched superblocks having the oldest timestamps. In some implementations, the size of the cache can be adjustable based on performance targets with respect to the data being compressed.

The stage 2 motion estimation 614 is performed using the motion center estimate 612 and data sent from the reference frame storage 610. The data sent from the reference frame storage 610 includes reference frames corresponding to the superblocks of the superblock list 608. The second motion search is performed using a second motion search window. The second motion search window can be a different motion search window from the first motion search window used during the stage 1 motion estimation 606. For example, where the stage 2 motion estimation 614 focuses on a smaller area of the frame than the stage 1 motion estimation 606, a size of the second motion search window of the stage 2 motion estimation 614 is smaller than a size of the first motion search window used during the stage 1 motion estimation 606. Alternatively, the second motion search window can be the same size as the first motion search window, but centered at a different pixel position than the first motion search window.

The second motion search window of the stage 2 motion estimation 614 is centered at a pixel position corresponding to the area of possible motion. As such, the second motion search window focuses the stage 2 motion estimation 614 on those superblocks of the superblock list 608 that are likely to include motion. Nevertheless, there may not be any penalty to performance where the stage 1 motion estimation 606 runs sufficiently far ahead of the stage 2 motion estimation 614, for example, where data resulting from the stage 1 motion estimation 606 remains in memory awaiting further processing. A motion estimation result 616 can be determined in response to the stage 2 motion estimation 614. The motion estimation result 616 is a motion vector identified based on the stage 2 motion estimation 614. The motion estimation result 616 can be used to generate a prediction block for encoding or decoding the current frame.

FIG. 7 is a flowchart diagram of a process 700 for super-wide area motion estimation for encoding or decoding frames of a video sequence. The process 700 can be implemented in a system such as the computing device 200 to aid in the encoding or decoding of a video stream. The process 700 can be implemented, for example, as a software program that is executed by a computing device such as the transmitting station 102 or the receiving station 106. The software program can include machine-readable instructions that are stored in a memory such as the memory 204 that, when executed by a processor such as the processor 202, cause the computing device to perform one or more operations comprising the process 700. The process 700 can also be implemented using hardware in whole or in part.

As explained above, some computing devices may have multiple memories and multiple processors, and the steps or operations of the process 700 may in such cases be distributed using different processors and memories. Use of the terms “processor” and “memory” in the singular herein encompasses computing devices that have only one processor or one memory as well as devices having multiple processors or memories that may each be used in the performance of some but not necessarily all recited steps.

For simplicity of explanation, process 700 is depicted and described as a series of steps or operations. However, steps and operations in accordance with this disclosure can occur in various orders and/or concurrently. Additionally, steps or operations in accordance with this disclosure may occur with other steps or operations not presented and described herein. Furthermore, not all illustrated steps or operations may be required to implement a method in accordance with the disclosed subject matter. Process 700 may be repeated for each frame of the input signal.

The process 700 begins at 702, where a first motion search is performed on a frame of a video sequence to be encoded or decoded. An area of possible motion within the frame is determined responsive to the first motion search. The first motion search is performed using a first motion search window having dimensions M×N. The center of the first motion search window corresponds to a position of a super index element of the frame. The super index element indicates a position of a pixel within a reference frame where motion was previously detected.

Performing the first motion search comprises calculating motion within the search window area of the first motion search window based on the position of the super index element. In particular, determining the area of possible motion comprises identifying the area in response to performing the first motion search by calculating motion using motion vector candidates from the super index element. The resulting area of possible motion determined via the first motion search indicates of a portion of the frame that likely includes motion (e.g., the portion of the frame to which to direct further motion search efforts).

A list of superblocks likely to include motion within the frame is identified based on the area of possible motion at 704. The area of possible motion determined at 702 can indicate one or more superblocks that may include motion within the frame. For example, a superblock within which at least a portion of the area of possible motion is located can be included in the list of superblocks. Those superblocks immediately adjacent to that superblock may also be included in the list of superblocks, as well as other superblocks based, for example, on the size of the area of possible motion.

Data indicative of the superblocks of the list of superblocks is stored within a cache in order to reduce the memory requirements for further processing (e.g., at following 706). If the data indicative of a particular superblock to be included in the list is already stored in the cache, it does not need to be restored; however, if the cache is full and data indicative of a superblock to be included in the list is not then-presently stored in the cache, other data then-currently stored in the cache can be deleted to make room. For example, the cache can implement a least-recently-used or other aging policy for deleting the oldest data stored therein to make room for the new data. The determination as to which data to delete from the cache includes referencing a timestamp associated with data stored (e.g., recorded at and indicative of the time the data was stored in the cache). The oldest data stored in the cache is the data having the oldest timestamp.

Other configurations for identifying the superblocks of the list of superblocks are possible. For example, identifying the superblocks of the list of superblocks can include computing a proximity between individual superblocks and the area of possible motion. A list of the superblocks identified can then be generated according to the computed proximities. In another example, identifying the list of superblocks can include receiving data indicative of the superblocks to include in the list from another processor. In another example, identifying the list of superblocks can include selecting superblocks to include in the list based on a database look-up, for example, where the results of the first motion search performed at 702 are stored in a database. In yet another example, identifying the list of superblocks can include determining which superblocks to include in the list based on a comparison between data received from another processor, data looked up in a database, and/or data calculated based on the area of possible motion.

At 706, once the list of superblocks has been identified, a second motion search is performed on one or more superblocks of the list of superblocks. The second motion search is performed using a second motion search window having dimensions A×B. The second motion search window can be smaller in size than the first motion search window used for performing the first motion search at 702. The center of the second motion search window corresponds to a position of the area of possible motion (e.g., a pixel position within the area of possible motion). For example, where the area of possible motion is a group of pixels or other portion of the frame to be encoded or decoded, the center of the second motion search window can be located at the center of the area of possible motion. In another example, where the area of possible motion indicates a single pixel, the center of the second motion search window can be positioned at the position of that single pixel. Performing the second motion search can include calculating motion within a search window area based on the area of possible motion.

A prediction block is generated based on the results of the second motion search at 708. In particular, the prediction block is generated based on a motion vector determined by the second motion search. The motion vector can be an optimal motion vector candidate determined by comparing or otherwise analyzing the motion vector candidates. During an encoding process, a block of the current frame is encodable using the prediction block. During a decoding process, a block of the current frame is decodable using the prediction block.

In practice, the entire super-indexed frame does not need to be stored in internal memory. For example, a rolling window approach can be used with regards to a reference frame storage for coding super-indexed frames such that only a portion of the frame may be required to be stored in internal memory. In this case, the memory requirements may be a fraction of that otherwise required for super-indexed superblocks. The encoder 400 or the decoder 500 may use a rolling window buffer as a compromise between onboard memory storage and bandwidth usage considerations. For example, for a tile having a width of 8 superblocks and a horizontal search range of +/−128 pixels, storage of luminance data can require a minimum of 118,784 bytes of external memory per reference frame. In practice, this approach can require additional storage for pre-fetching data from external memory, which can increase the minimum memory requirement per reference frame to 147,456 bytes.

Using the implementations of the present disclosure, a motion search window can be dynamically moved within a large area (e.g., up to the entire dimensions of a frame) at relatively little additional cost to external memory because of the use of super indexes. There is a potential to save total internal memory bandwidth when using tile coding since overlapping data on tile boundaries does not need to be read. Further, by virtue of super indexing, the total number of operations required to evaluate a given motion vector candidate can be minimized (e.g., 4,096 operations for 64×64 luminance in the pixel domain, 16 operations for similar area in super-index domain).

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” or “aspect” is used herein to mean serving as an example, instance, or illustration. Any aspect or design described herein as “example” or “aspect” is not necessarily to be construed as preferred or advantageous over other aspects or designs. Rather, use of the word “example” or “aspect” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of this disclosure and do not limit this disclosure. On the contrary, this disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. An apparatus for encoding a block of a current frame of a video sequence, the apparatus comprising:
a processor configured to execute instructions stored in a non-transitory storage medium to:
perform a first motion search on the current frame to determine an area of possible motion;
identify a list of superblocks likely to include motion within the current frame based on the area of possible motion;
perform a second motion search on one or more superblocks of the list of superblocks; and
generate a prediction block based on results of the second motion search, wherein the block of the current frame is encodable using the prediction block.

2. The apparatus of claim 1, wherein the first motion search is performed using a first motion search window having a center corresponding to a position of a super index element of the current frame, and
wherein the second motion search is performed using a second motion search window having a center corresponding to a position of the area of possible motion.

3. The apparatus of claim 2, wherein the super index element corresponds to a pixel of a reference frame usable for encoding the block of the current frame.

4. The apparatus of claim 2, wherein a size of the second motion search window is smaller than a size of the first motion search window.

5. The apparatus of claim 1, wherein the processor is configured to execute instructions stored in the non-transitory storage medium to identify the list of superblocks likely to include motion within the current frame by:
identifying at least one superblock adjacent to a superblock including at least a portion of the area of possible motion, wherein the list of superblocks includes the superblock and the at least one superblock.

6. The apparatus of claim 5, wherein the processor is configured to execute instructions stored in a non-transitory storage medium to:
store data indicative of a superblock of the list of superblocks within a cache responsive to an identification of the superblock,
wherein the second motion search is performed using the data stored within the cache.

7. The apparatus of claim 1, wherein the results of the second motion search include a motion vector indicative of a motion estimation for the block of the current frame.

8. An apparatus for decoding a block of an encoded frame included in an encoded bitstream, the apparatus comprising:
a processor configured to execute instructions stored in a non-transitory storage medium to:
perform a first motion search on the encoded frame to determine an area of possible motion;
identify a list of superblocks likely to include motion within the encoded frame based on the area of possible motion;
perform a second motion search on one or more superblocks of the list of superblocks; and
generate a prediction block based on results of the second motion search, wherein the block of the encoded frame is decodable using the prediction block.

9. The apparatus of claim 8, wherein the first motion search is performed using a first motion search window having a center corresponding to a position of a super index element of the encoded frame, and
wherein the second motion search is performed using a second motion search window having a center corresponding to a position of the area of possible motion.

10. The apparatus of claim 9, wherein the super index element corresponds to a pixel of a reference frame usable for decoding the block of the encoded frame.

11. The apparatus of claim 9, wherein a size of the second motion search window is smaller than a size of the first motion search window.

12. The apparatus of claim 8, wherein the processor is configured to execute instructions stored in the non-transitory storage medium to identify the list of superblocks likely to include motion within the encoded frame by:
identifying at least one superblock adjacent to a superblock including at least a portion of the area of possible motion, wherein the list of superblocks includes the superblock and the at least one superblock.

13. The apparatus of claim 12, wherein the processor is configured to execute instructions stored in a non-transitory storage medium to:
store data indicative of a superblock of the list of superblocks within a cache responsive to an identification of the superblock,
wherein the second motion search is performed using the data stored within the cache.

14. The apparatus of claim 8, wherein the results of the second motion search include a motion vector indicative of a motion estimation for the block of the encoded frame.

15. A method for decoding an encoded video signal using a computing device, the encoded video signal including an encoded frame, the method comprising:
performing a first motion search on the encoded frame to determine an area of possible motion;
identifying a list of superblocks likely to include motion within the encoded frame based on the area of possible motion;
performing a second motion search on one or more superblocks of the list of superblocks; and
generating a prediction block based on results of the second motion search, wherein a block of the encoded frame is decodable using the prediction block.

16. The method of claim 15, wherein the first motion search is performed using a first motion search window having a center corresponding to a position of a super index element of the encoded frame,
wherein the second motion search is performed using a second motion search window having a center corresponding to a position of the area of possible motion, and
wherein a size of the second motion search window is smaller than a size of the first motion search window.

17. The method of claim 16, wherein the super index element corresponds to a pixel of a reference frame usable for decoding the block of the encoded frame.

18. The method of claim 15, wherein identifying the list of superblocks likely to include motion within the encoded frame based on the area of possible motion comprises:
identifying at least one superblock adjacent to a superblock including at least a portion of the area of possible motion, wherein the list of superblocks includes the superblock and the at least one superblock.

19. The method of claim 18, the method comprising:
storing data indicative of a superblock of the list of superblocks within a cache responsive to an identification of the superblock,
wherein the second motion search is performed using the data stored within the cache.

20. The method of claim 15, wherein the results of the second motion search include a motion vector indicative of a motion estimation for the block of the encoded frame.
